(19) United States
(12) Patent Application Publication
(10) Pub. No.: US 2025/0004346 A1
(43) Pub. Date: Jan. 2, 2025

(54) TUNABLE COUPLED FLUORESCENCE DISPLAY DEVICES

(71) Applicant: HALION DISPLAYS INC., Kitchener (CA)

(72) Inventors: Ryan Phillip Marchewka, Kitchener (CA); Matthew Thomas Lavrisa, Ottawa (CA)

(21) Appl. No.: 18/756,515

(22) Filed: Jun. 27, 2024

Related U.S. Application Data
(60) Provisional application No. 63/523,504, filed on Jun. 27, 2023.

(51) Int. Cl. G02F 1/1677; G02F 1/167; G02F 1/1676; G02F 1/1685

(52) U.S. Cl. CPC G02F 1/1677; G02B 6/0066; G02F 1/167; G02F 1/1676; G02F 1/1685; G02F 2202/046

(57) ABSTRACT

An example electrophoretic luminescent device includes: an outer substrate and an inner substrate, one of which is a waveguide material, or includes a waveguide layer; a light source, the light from which is coupled to the waveguide material or waveguide layer; and at least one tunable fluorescent layer comprising: a driven electrode and a reference electrode, the driven electrode and the reference electrode disposed in a spaced apart relationship between the inner substrate and the outer substrate; an electrophoretic media, the electrophoretic media comprising a fluorescent charged nanoparticle, oppositely charged polymers or nanoparticles to balance the charge, the fluorescent charged nanoparticles inducible to fluoresce when they are within the evanescent field of the waveguide; and a controller coupled to the driven electrode, the controller to drive the driven electrode to induce a voltage difference to change the electromagnetic field applied to the electrophoretic media.

### FIELD

The specification relates generally to luminescent devices, and more particularly to electrophoretic devices which may be induced to fluoresce or stop fluorescing at different areas of the device.

### BACKGROUND

Various technologies are employed in the manufacture of display panels. Some, e.g. liquid crystal and electrowetting displays, suffer from optical losses and cannot be made substantially transparent. Others, such as OLED, require careful processing and encapsulation to avoid unwanted side reactions with the electroluminescent materials.

### DETAILED DESCRIPTION

To date, there are few examples of emissive displays which are substantially transparent. OLED displays may be capable of this but require the use of expensive materials and extremely careful processing steps to avoid contamination of the display by water and oxygen, which may quickly damage the electroluminescent materials. In one aspect of the present invention, a display device is provided which fills this gap, by providing an easy-to-fabricate luminescent display which offers refresh rates suitable for video and is substantially transparent.

Such a technology may be used not only for display applications, but other applications which require a surface to glow with a particular color.

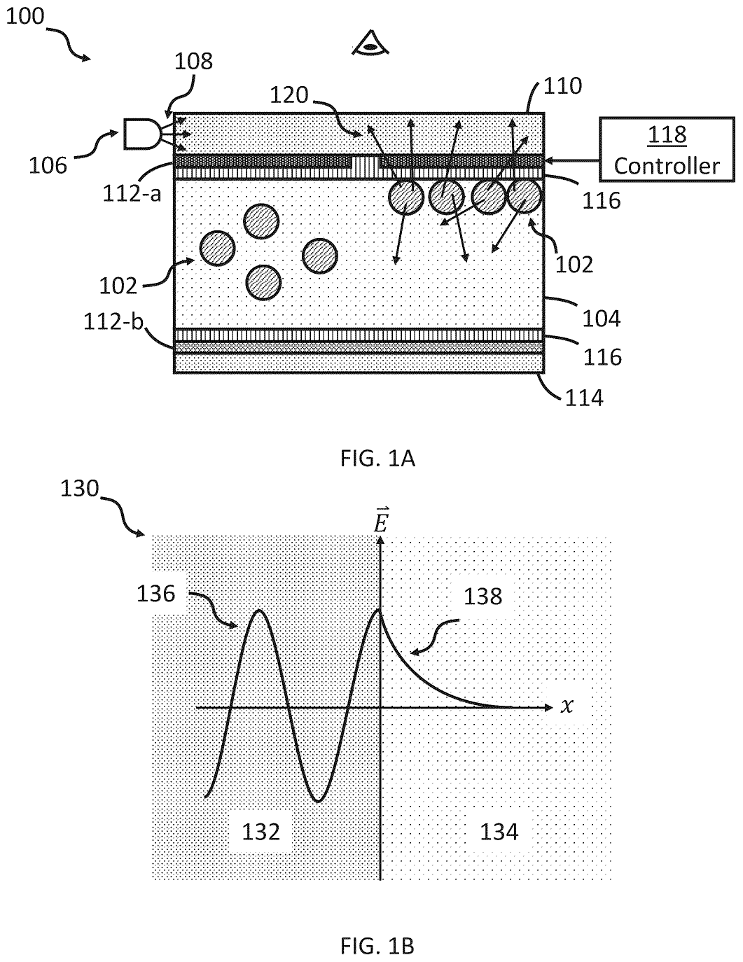

Turning to FIG. 1A a schematic diagram illustrates a single layer display stack 100, comprising electrophoretic fluorescent nanoparticles 102 in dispersion fluid 104. An illumination source 106 provides guided light 108 which may be used to excite the fluorophore in electrophoretic fluorescent nanoparticles 102. The guided light 108 is substantially trapped within waveguide 110. The guided light 108 may comprise one or more frequencies of light which correspond to visible light or ultraviolet light. Deposited on waveguide 110 are driven electrodes 112-a. Reference electrode 112-b is deposited onto a second substrate 114 which holds in the dispersion fluid 104. The electrodes 112 may be coated with a dielectric barrier 116, which may be formed from a material which is insoluble in the dispersion fluid 104. The dielectric barriers 116 may be formed from a vacuum deposited transparent material such as silicon nitride, or silicon dioxide. It may also be formed from a layer of polymer which may be applied via a spin-coating process, for example. It may also be formed from a molecular monolayer, such as by the addition of a silane-based monolayer such as n-octyl triethoxy silane. The driven electrodes 112-a may be controlled by controller 118, which applies an electrical potential relative to the reference electrode 112-b. The electric potential difference may be chosen so as to attract the electrophoretic fluorescent nanoparticles 102, which may be substantially all similarly charged. For instance, if the electrophoretic fluorescent nanoparticles 102 are negatively charged, applying a positive potential difference to the driven electrode 112-a relative to the reference electrode 112-b will draw the electrophoretic fluorescent nanoparticles 102 towards that driven electrode 112-a. When the electrophoretic fluorescent nanoparticles 102 are close enough to the waveguide, typically a distance of a few hundred nanometers or less, the electrophoretic fluorescent nanoparticles 102 may be within the region of the evanescent wave of the waveguide, may frustrate the total internal reflection that would otherwise happen, absorb the guided light 108 and may produce fluoresced light 120 in all directions. Removing the voltage difference on the driven electrode 112-a allows the particles to drift back into the bulk of the solution where they may no longer fluoresce substantially. In some embodiments there may be additional substrate layers beyond the waveguide layer. In some examples, all layers are substantially transparent to visible light, so that the whole display stack 100 is substantially transparent.

FIG. 1B is a schematic diagram showing an electromagnetic wave arriving at an interface 130 which produces an evanescent wave. An interface between high refractive index medium 132 and low refractive index medium 134 is depicted, with the distance from the interface being represented by the axis labelled x. The other axis, labelled E, is the electric field strength. An example impinging electromagnetic wave 136 is depicted impinging upon the interface. This wave is substantially reflected by the interface (not shown), but by the solution of Maxwell's equations, an evanescent wave 138 extends into the low refractive index medium 134. This does not transmit power into the low index medium unless it comes across a molecule which can absorb that wavelength of light, in which case that may happen. By bringing such molecules into or out of this region as depicted in FIG. 1A, this light may be used to produce fluorescence. This fluorescence may be stopped by removing the molecule from the evanescent wave region.

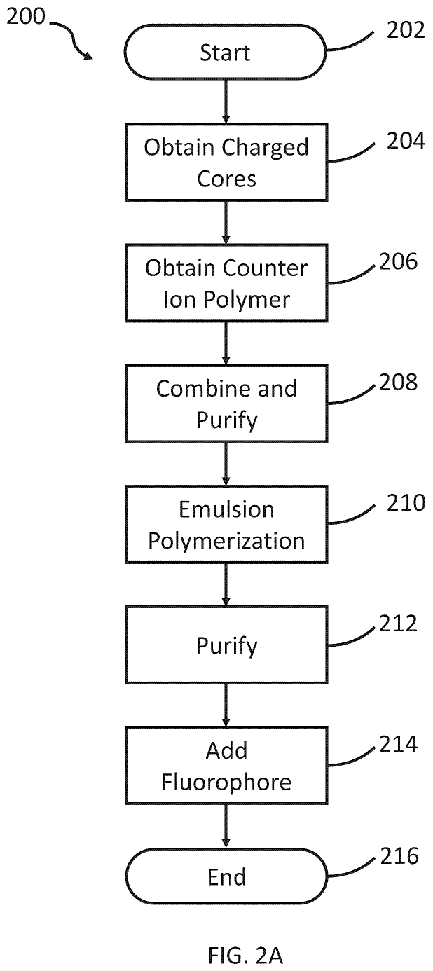

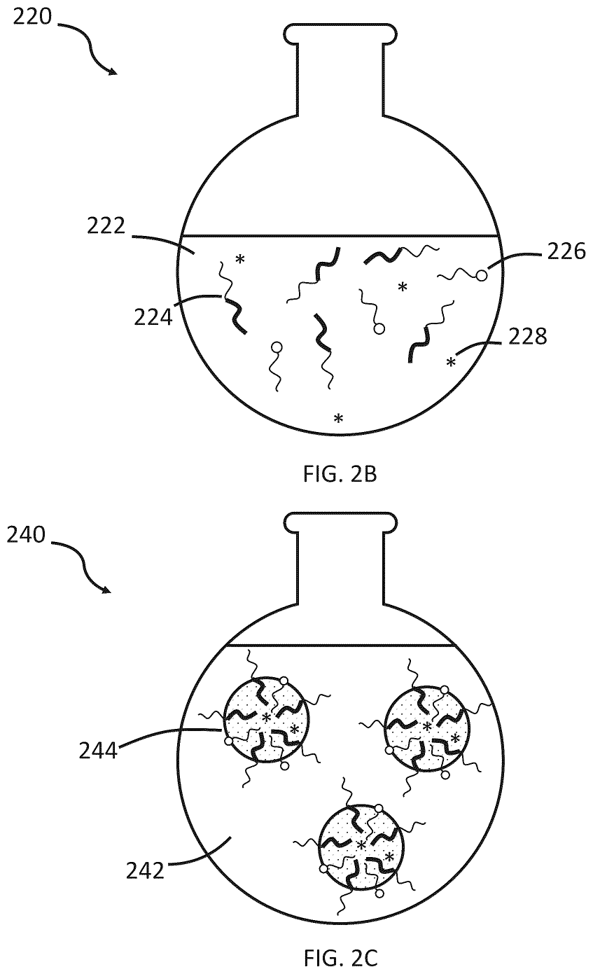

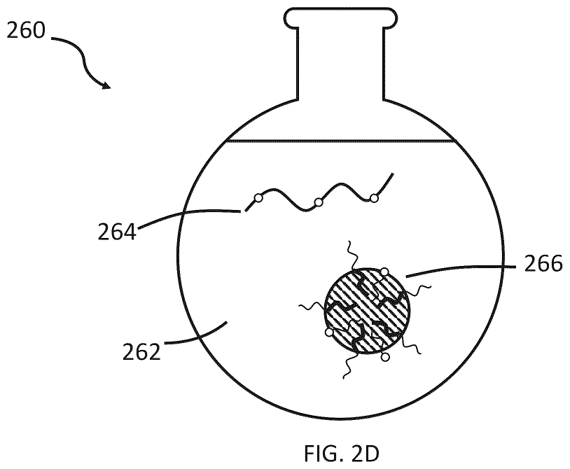

FIG. 2A is a flow chart of an example method 200 of producing the electrophoretic dispersion of the tunable coupled fluorescent display device. At block 202 the method is started. At block 204, charged cores are produced. This may be performed by a number of means, resulting in charged nanoparticles. A detailed example will be provided below. At block 206, a counter ion polymer bearing the opposite charge is produced. In some examples, the polarity of this counter ion polymer is opposite that of the charged cores. If the charged cores are hydrophilic, the counter ion polymer is hydrophobic, for example. At block 208, the charged cores are combined with the counter ion polymer in a solvent which can dissolve them both, in a ratio so that in total there are as many charge-bearing moieties on the counter ion polymer molecules as there are in total on the charged cores. The resulting mixture may be purified to remove the excess counter ions which are not covalently attached to the polymer or the molecules, for example by dialysis, centrifugation, settling, or other methods. At block 210, an emulsion polymerization step is carried out in a solvent which has a polarity suitable to dissolve the counter ion polymer. Examples of solvents include heptane or cyclohexane if the solvent is to be nonpolar, or methanol or water if the solvent is to be polar. It is preferable that the refractive index of the solvents chosen is lower than that of the waveguide material, to allow the waveguide to function, and permit the formation of an evanescent wave. Solvents with lower vapor pressures may also be preferable, as this will limit the evaporation of the solvent from the device. The mixture obtained at block 208 is injected into a solvent which carries surfactant. In some examples, the solvent has the opposite polarity to the charged cores and the same polarity as the counter ion polymer molecules, so that the counter ion polymer molecules are dissolved in the solvent and the surfactant is needed to stabilize the charged cores. The emulsion polymerization adds monomer on top of the charged cores, producing a larger charged particle, while the counter ion polymer remains dissolved in the solvent of the emulsion polymerization.

At block 212, the resulting emulsion polymer is purified. This may involve separating out particles which do not have a charge or which have the wrong polarity charge, or which are too large or small. The purification step may also include the exchange of solvents by dialysis or centrifugation for example. At block 214, fluorophore is added to the cores. This may be done for example by suspending a powder of the fluorophore in the emulsion polymerization solvent and mixing for an extended period of time. The powder does not dissolve in the solvent, but does dissolve in the charged cores, so that it becomes localized in the charged cores over time. Remaining undissolved fluorophore can be filtered out. In other examples, the fluorophores may be added to the cores in the form of a polymeric corona having fluorescent dyes attached thereto. That is, the polymeric corona may include polymeric arms having fluorescent dyes. The polymeric arms may then be attached to the charged core to form the polymeric corona and add the fluorophores to the core.

In other example methods, these same steps may be performed, but in different orders. For example, the counter polymer may be synthesized before the charged cores, or at the same time. In addition, some steps may be added or omitted or changed, for example the first purification step may be omitted in some examples. In other examples, the function of the charged core could instead be replaced by a charged polymer with similar solubility.

FIG. 2B depicts an example of the performance of block 204. A reaction vessel containing precursor solution 220 is depicted. The precursor solution 220 comprises monomer solvent 222, which in the present example is a mixture of butyl methacrylate and 1,4-dioxane. Other monomers may be used as well, or mixtures of monomers. Also dissolved in the precursor solution 220 is an amphiphilic block copolymer 224, which in the present example has a polybutadiene block, and a polyethylene glycol block. Also dissolved in precursor solution 220 is a charged surfmer 226 such as 11-sulfoundecyl methacrylate potassium salt, as well as a thermal initiator or photoinitiator such as 2-hydroxy-2-methylpropiophenone. In this example the monomer chosen for the monomer solvent 222, butyl methacrylate, is substantially hydrophobic, but other hydrophobic monomers could work as well, for example styrene or styrene derivatives, other methacrylates, acrylates, or vinyl monomers, or monomers which may be polymerized by ring opening. Monomers which polymerize via step growth polymerization can be used as well but may be more limited in their applicability or selection. The block copolymer 224 is chosen to have a longer hydrophilic block than hydrophobic block, so that it will tend to behave like an oil-in-water surfactant. In other examples, the monomer could be hydrophilic such as vinyl pyrrolidone, acrylamide or others.

FIG. 2C depicts a nanoemulsion 240 formed from the same precursor solution 220 after it has been added to water under vigorous agitation. Because the block copolymer and surfmer were selected to be hydrophilic, and they were suspended in a hydrophobic medium, the addition to water results in Rayleigh instabilities at the interface between the precursor solution 220 and the water phase 242, which quickly break up into nanoemulsion droplets 244 which are relatively monodisperse. This nanoemulsion can then be irradiated with 256 nm ultraviolet light in this example to crosslink the core by activating the photoinitiator in nanoemulsion droplets 244. This yields the crosslinked charged cores of block 204.

Turning now to FIG. 2D, we find purified seed solution 260, which comprises a suspension solvent 262, a counter ion polymer 264, and the crosslinked charged cores 266, the such as those obtained after irradiation of nanoemulsion 240. The suspension solvent 262 is chosen to be of intermediate polarity such that it is able to dissolve both the counter ion polymer 264 and the crosslinked charged cores 266. The counter ion polymer 264 as described previously has a polarity which is substantially different to the crosslinked charged cores 266. For example, it may comprise styrene monomers as well as a charged styrene derivative such as 4-vinylbenzyltrimethylammonium bromide. In this example, the styrene monomers greatly outnumber the charged styrene derivatives such that each polymer chain has only a few charged moieties per molecule. This is so that it remains substantially oil soluble and water insoluble which may be preferable. In this example, the total number of ammonium functional groups on all of the counter ion polymer 264 molecules is preferably substantially the same as the total number of sulfonate groups on all of the crosslinked charged cores 266. The solution may then be purified of particles which have the wrong polarity charge, no net charge, or too little charge, a process which will be described in more detail below. The solution may also be purified to remove ions which are not covalently bound to the counter polymer or charged cores, for example by dialysis in solvents such as dimethylsulfoxide which can dissolve trace amounts of salt as well as the constituents of the solution.

In the present example, this solution, once purified, undergoes an emulsion polymerization in heptane, using sorbitan monostearate as an emulsifying agent. Other examples may use solvents other than heptane, for example cyclohexane, or other nonpolar solvents, or polar solvents such as water or methanol. The mixture is degassed with nitrogen and then the temperature is increased to 65 Celsius. An emulsion containing acrylamide and bisacrylamide dissolved in water, suspended in heptane with the help of further sorbitan monostearate is prepared. Thermal initiator such as 2,2′-azobisisobutyronitrile is added to the mixture, initiating the reaction. The monomer emulsion is added dropwise to the emulsion polymerization reaction over the course of an hour, and the polymerization is allowed to proceed for an additional hour. The polymerization is concluded by removal from the heat source and introduction of air. The mixture is allowed to settle over at least 24 hours, and the supernatant is separated from the precipitate and kept. The particles are purified by charge as described in more detail below, and then fluorophore is added to the particles to conclude the process of preparing the ink. In the present example, the fluorophore used is 8-anilino-1-naphthalenesulfonic acid.

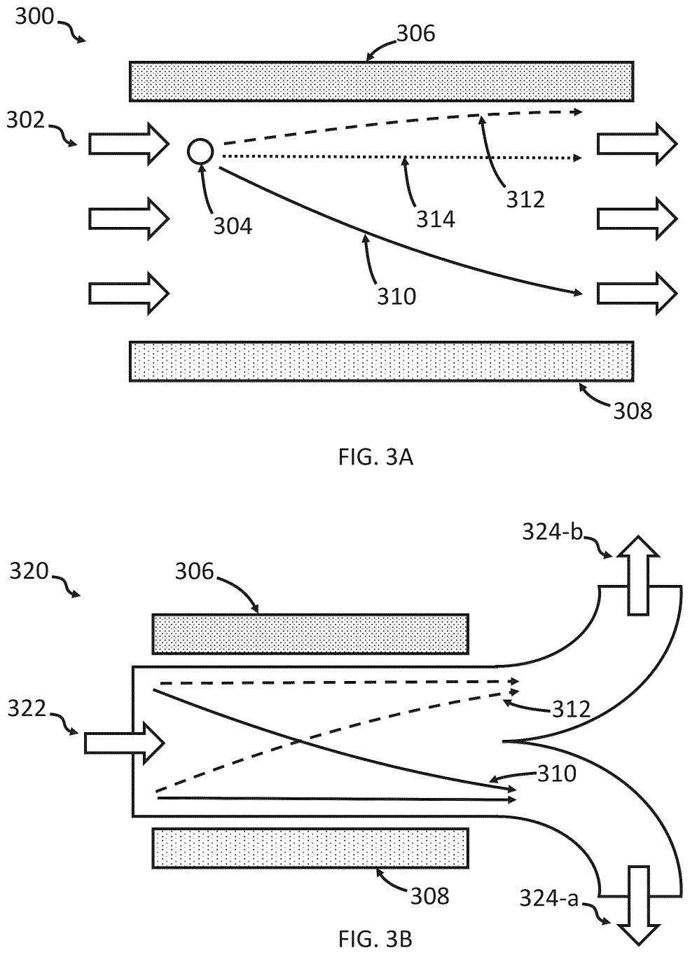

Turning now to FIG. 3A is a schematic diagram of a first example of a method of purifying electrophoretic nanoparticles termed free flow electrophoresis. The free flow electrophoretic separation device 300 comprises a running fluid 302 which is injected into a channel at one end, exiting the channel at the other end after which point the flows may be separated by physical separation methods. The running fluid 302 is meant to flow in a substantially laminar flow regime to reduce unwanted particle diffusion across the channel. Into the running fluid 302, an injection port 304 injects the unpurified ink. The channel is surrounded by a first electrode 306 and a second electrode 308 to which are applied an electric potential difference, producing an electric field across the channel. The electric field pulls particles with the desired sign of charge 310 to the opposite side of the channel from the injection port 304, in the opposite direction from the particles with the undesired charge 312. The minimally charged particles are substantially unaffected by the electric field and flow with the running fluid. The running fluid and the length of the channel are such that under the applied electric field, the particles have enough time to migrate to the appropriate side of the channel, to achieve the desired separation. Conversely, the electric field may be increased to allow for faster separation.

FIG. 3B depicts a schematic diagram of a second example of a method of purifying electrophoretic nanoparticles which is also based on the concept of free flow electrophoresis, but which does not have a running fluid which differs from the injected nanoparticle suspension. The single source electrophoretic separation device 320 comprises an input 322 of unpurified electrophoretic particles which then flow through a channel which splits into two outputs 324, each with a different net polarity of nanoparticles. The neutral particles are divided approximately evenly between the two outputs. Multiple passes can be used to reduce the concentration of neutrally charged particles. As with FIG. 3B, a first electrode 306 and second electrode 308 supply an electric field which pulls the particles with the desired sign of charge 310 to one side of the channel to be collected by one of the two outputs 324-a. Particles with the undesired charge 312 are pulled to the other side of the channel to be collected by the other of the two outputs 324-b. The flow rate of the particle suspension and the length of the channel are such that under the applied electric field, the particles have enough time to migrate to the appropriate side of the channel, to achieve the desired separation. Conversely, the electric field may be increased to allow for faster separation.

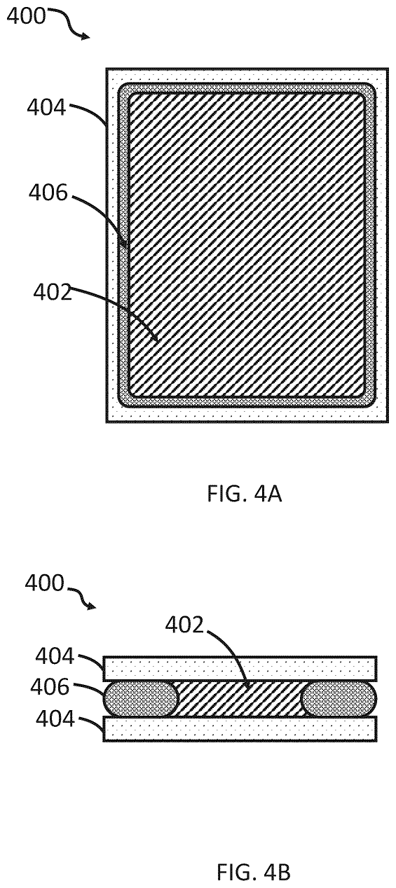

FIG. 4A is a schematic diagram of an example display device 400 where the fluorescent electrophoretic ink 402 is contained within the display device by substrates 404 and sealant material 406. The sealant material may be chosen to prevent the migration of any component of the electrophoretic dispersion out of the display, as well as to be insoluble and robust against any component of the electrophoretic dispersion. It may also be preferable that the sealant material prevents the diffusion of atmospheric gases, water, debris, or other material into the display. As described elsewhere in this disclosure, the substrates may include several other layers for other purposes other than just containment of electrophoretic dispersion and microstructures.

FIG. 4B is a schematic diagram of the cross section of the display device 400 comprising electrophoretic dispersion and microstructures 402, substrates 404, and sealant material 406 of FIG. 4A.

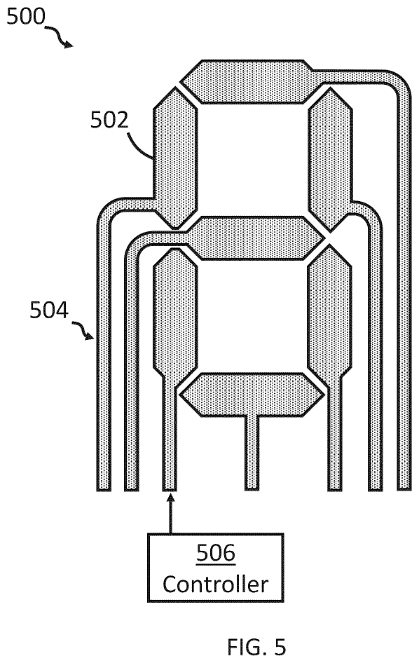

Turning now to FIG. 5 is a schematic diagram of an example segmented display driven electrode pattern 500. This pattern is made up of one or more segments 502 which make up the driven electrode. These segments 502 may be made of transparent conductor, or of an opaque conductor if they are not on the side of the viewer. This is an example method for varying the applied electric field over the surface of the display to form an image, referred to as a segmented display. Each of the segments 502 is connected to the edge of the display by a trace 504 made up of a conductive material, preferably the same conductive material as the segments 502. Each of the segments is connected to a controller 506, which supplies a voltage to the segment so that the voltage difference between the segment and the reference electrode produces an electric field to actuate the electrophoretic dispersion's color.

The reference electrode (not shown) is deposited onto an opposing substrate. may also be made up of one or more segments connected to the edge of the substrate by traces, or there may be one or more zones of reference electrode which touch the edges of the substrate. The reference electrode may be made of transparent conductor, or of an opaque conductor if they are not on the side of the viewer. These segments are connected to the display's common voltage, or to a controller.

The region which is actuated is approximately the intersection of the driven electrode and reference electrode when viewed in this manner. Other patterns of electrodes may be used depending on the information which is to be displayed. The driving method discussed in this example is referred to as direct drive. The configuration of the segments may allow for other driving methods, which may reduce the number of inputs required to drive the segments independently which may occur to those skilled in the art.

Different waveforms may be used to drive the segments 502 which may be familiar to those skilled in the art. One example is a direct drive method in which a DC voltage is applied to the segment 502 for as long as the image is to be maintained. Examples of other driving schemes include applying a short pulse of reversed polarity potential difference across the electrodes, to keep the nanoparticles in motion and reduce the amount of aggregation of the particles at the electrode, constantly applying an AC voltage to the electrodes for the same purpose, which may be a square wave, sine wave, or other waveform. DC offsets may be applied to the AC voltage to bias the particles towards or away from the waveguide on the average.

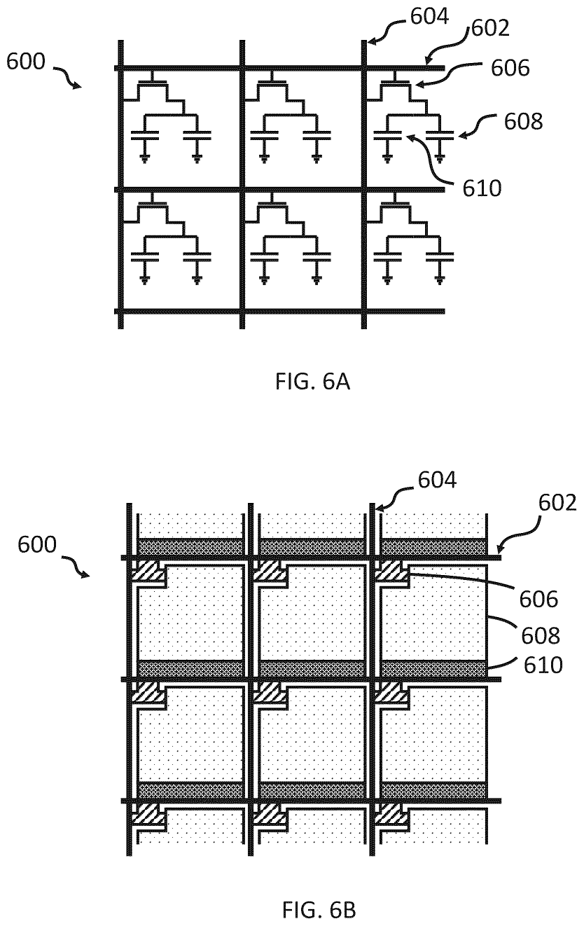

FIG. 6A is a schematic electronic diagram of an array of pixels which are addressed by a thin film transistor (TFT) array 600. In this example, the horizontal conductive traces are referred to as select lines 602 and the vertical conductive traces are called data lines 604. The select lines are connected to the gate terminals of thin film transistors 606, and the data lines are connected to the source terminals of the thin film transistors. When a voltage is applied to the select line, the channels of the thin film transistors connected to that select line become conductive. When the channels of the thin film transistors are rendered conductive, voltage signals from the data lines can propagate into the pixel's driven electrode 608. There may also be a storage capacitor 610 in each pixel which may help to maintain the voltage at a constant level for a time, preferably until the pixel is addressed again. When the voltage signals from the data lines are applied to the conductive pad and the storage capacitor, the electric field across the electrophoretic dispersion layer changes which may change the position of the fluorescent electrophoretic nanoparticles. Once the voltage on the select line is set low, the row is no longer being addressed, and the pixel may approximately maintain its voltage until the next time its row is addressed by the select line. In this way, the display controller may cycle through the rows of the display, updating each in turn to build up an image, and change it periodically, every time a cycle is completed.

FIG. 6B is a schematic diagram of the approximate physical layout of the components in the TFT array 600. Because the layers of a multi-layer color changing display are stacked, the pixels in the display may be square, or may be some other shape. The shape is defined by the relative spacing of the select lines 602 and data lines 604, and by the driven electrode 608.

In the present example, the grounded terminal of the storage capacitor 610 is connected to the select line of the adjacent row of pixels. While the select line which drives the storage capacitor's row of pixels is high, the other select lines are low, which allow them to act as a ground for the capacitor. Other arrangements are possible, for example, there may be an additional reference electrode for each row of the display, and the grounded terminal of the storage capacitors in each row may instead be connected to that line.

In some embodiments, the fraction of the total pixel area taken up by the select lines, data lines, thin film transistors and storage capacitors is as small as possible, to maximize the amount of area taken up by the pixel driven electrodes, and thus maximizing the transparency of the display.

In some embodiments, the thin film transistors are made using a transparent semiconductive material such as indium gallium zinc oxide, aluminum doped zinc oxide, or poly(3,4-ethylenedioxythiophene) polystyrene sulfonate, to reduce the blockage of light by the thin film transistor. In some embodiments the storage capacitor is made using a transparent conductive material to reduce the blockage of the light by the storage capacitor and improve the contrast and brightness of the display.

In some embodiments, there may be additional conductive materials deposited between the data lines and the semiconducting materials of the TFT to reduce the contact resistance of the junction that is formed there.

Different waveforms may be used to drive each of the pixels in the pixel array 600 which may be familiar to those skilled in the art. One example is a direct drive method in which a DC voltage is applied to the pixel for as long as the image is to be maintained. Examples of other driving schemes include applying a short strong pulse of reversed polarity potential difference across the pixel before the signal is sent to the pixel which will be maintained for the duration of the image frame, to keep the nanoparticles in motion and reduce the amount of aggregation of the particles at the electrode, and may also help prevent charge accumulation within the transistor which may change the transistors' electrical characteristics. With a different transistor array involving two thin film transistors per pixel (not shown), another example of a driving scheme may be constantly applying an AC voltage to the pixels, which may be a square wave, sine wave, or other waveform. DC offsets may be applied to the AC voltage to bias the particles towards or away from the waveguide on the average.

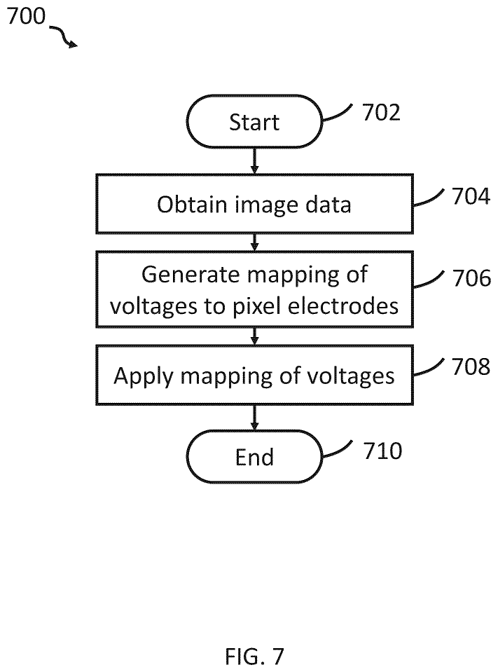

FIG. 7 is a flowchart of an example method 700 of driving the display device.

At block 702, the method 700 is initiated. The method 702 may begin at an update or refresh of an image frame corresponding to an image to be displayed by the display device.

At block 704, image data representing an image to be displayed by the electrophoretic display device is obtained. The image data may map an image to be displayed by the display device to one or more pixels of the display device. In other words, the obtained image data corresponds to at least one pixel of the electrophoretic display device. The image data includes instructions for brightness values to be adopted by pixels of the display device. As another example, the image data may include instructions for voltages to be applied to electrodes coupled to pixel chambers corresponding to the pixels of the display device to achieve display of the image. Image data may be obtained at a display driver coupled to the electrodes.

At block 706, a mapping of voltages to pixel electrodes of the electrophoretic display device is generated. The pixel electrodes control pixels (e.g., as defined by regions of the display device containing the electrophoretic media) containing the fluorescent electrophoretic nanoparticles which may be induced to fluoresce more when brought near the waveguide by an appropriately directed electric field, or induced to fluoresce less when brought away from the waveguide by an appropriately directed electric field. In other words, the pixel electrodes control the pixels of the display device. The voltage may be applied to each pixel driven electrode relative to the reference electrode. At block 708, the mapping of voltages is applied to the pixel driven electrodes to induce a greater or lesser degree of fluorescence of the fluorescent electrophoretic nanoparticles. The mapping of voltages may be applied to one or more pixel driven electrodes. In other words, a voltage is applied to at least one pixel driven electrode coupled to a pixel of the display device. Application of the voltage results in adjustment of an electromagnetic field passing through one or more pixel. The applied voltage may substantially generate the electromagnetic field, substantially eliminate the electromagnetic field, increase the strength of the electromagnetic field, decrease the strength of the electromagnetic field, or switch the direction of the electromagnetic field.

Further, adjustment of the electromagnetic field results in the fluorescent electrophoretic nanoparticles moving within the range of the evanescent wave or outside of it, changing the degree to which they fluoresce more brightly or less brightly, respectively.

At block 710 the method is ended. However, it is to be understood that any of the blocks of the method 700 may be repeated as necessary for the display of an image or video on the display device.

The scope of the claims should not be limited by the embodiments set forth in the above examples, but should be given the broadest interpretation consistent with the description as a whole.

1. An electrophoretic luminescent device comprising:
an outer substrate and an inner substrate, one of which is a waveguide material, or includes a waveguide layer;
a light source, the light from which is coupled to the waveguide material or waveguide layer; and
at least one tunable fluorescent layer comprising:
a driven electrode and a reference electrode, the driven electrode and the reference electrode disposed in a spaced apart relationship between the inner substrate and the outer substrate;
an electrophoretic media, the electrophoretic media comprising a fluorescent charged nanoparticle, oppositely charged polymers or nanoparticles to balance the charge, the fluorescent charged nanoparticles inducible to fluoresce when they are within the evanescent field of the waveguide; and
a controller coupled to the driven electrode, the controller to drive the driven electrode to induce a voltage difference to change the electromagnetic field applied to the electrophoretic media.

2. The electrophoretic luminescent device of claim 1, further comprising additional tunable fluorescent layers, each additional tunable fluorescent layer comprising:
an additional waveguide layer and coupled light source;
an additional driven electrode and an additional reference electrode, the additional driven electrode and the additional reference electrode disposed in a spaced apart relationship between the inner substrate and the outer substrate;
an additional fluorescent electrophoretic media; and
an additional controller coupled to the additional driven electrode, the additional controller to drive the additional driven electrode to induce a voltage difference to change an additional electromagnetic field applied to the additional electrophoretic media.

3. The electrophoretic luminescent device of claim 1, wherein the driven electrode comprises two or more segments, each segment connected to the controller via a trace; and wherein the controller is to selectively drive the two or more segments to form a segmented display image.

4. The electrophoretic luminescent device of claim 1, wherein the driven electrode comprises an array of pixel driven electrodes, each pixel driven electrode corresponding to a pixel of the electrophoretic display device.

5. The electrophoretic luminescent device of claim 4, further comprising a plurality of select lines and data lines coupled to the controller; and wherein the controller is to cycle through the select lines and the data lines to selectively drive the pixel driven electrodes to build an image at the electrophoretic display device.

6. The electrophoretic luminescent device of claim 1, further comprising a light reflecting layer adjacent to the inner substrate, the light reflecting layer to reflect light back through the color-changing layer to a viewer.

7. The electrophoretic luminescent device of claim 1, further comprising a light absorbing layer adjacent to the inner substrate, the light absorbing layer to provide additional contrast for the viewer.

8. The electrophoretic display device of claim 1, wherein the inner and outer substrates, and the driven and reference electrodes are substantially transparent to allow light to be transmitted therethrough.

9. A method of producing an electrophoretic dispersion comprising:
obtaining a charged core having a charge;
obtaining a counter ion polymer bearing a charge opposite to the charge of the charged core;
combining the charged core and the counter ion polymer;
applying an emulsion polymerization in a solvent with a polarity configured to dissolve the counter ion polymer to enlarge the charged core;
purifying the charged core; and
adding a fluorophore to the charged core.

10. The method of claim 9, combining the charged core and the counter ion polymer is performed in a solvent configured to dissolve the charged core and the counter ion polymer.

11. The method of claim 9, wherein the solvent for the emulsion polymerization comprises a surfactant to stabilize the charged core.

12. The method of claim 9, wherein adding the fluorophore comprises suspending a powder of the fluorophore in the solvent of the emulsion polymerization and mixing.

13. The method of claim 9, wherein adding the fluorophore comprises adding a polymeric corona having fluorescent dyes to the charged core.

14. The method of claim 9, wherein the solvent for the emulsion polymerization comprises one of: heptane, cyclohexane, methanol, or water.

15. The method of claim 9, wherein purifying the charged core comprises exchanging solvents by dialysis or centrifugation.
